(19) United States
(12) Patent Application Publication
(10) Pub. No.: US 2002/0197379 A1
(43) Pub. Date: Dec. 26, 2002

(54) Cold water soluble tea concentrate

(75) Inventors: Grace George, Bangalore (IN); Skand Saksena, Bangalore (IN)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/161,875

(22) Filed: Jun. 4, 2002

(30) Foreign Application Priority Data
Jun. 8, 2001 (IN) 532/MUM/01

(51) Int. Cl. A23F 3/00

(52) U.S. Cl. 426/597

(57) ABSTRACT

A process for making a concentrated cold water soluble tea product. The process involves extracting tea material with water to give a tea extract, deleafing the tea extract, concentrating the deleafed tea extract, decreaming the concentrated tea extract, concentrating the decreamed tea extract to give a concentrated cold water soluble tea product. An anionic colloidal material is added between the deleafing step and the decreaming step to generate colour and minimise haze. The tea concentrate can be dried to give an instant tea powder or used to make ready to drink tea with good colour and clarity.

The present invention relates to a process for making a concentrated cold water soluble tea product from which one can make a tea beverage with good clarity and colour.

### BACKGROUND OF THE INVENTION

Black leaf tea is traditionally produced by oxidising and drying freshly plucked green tea leaves. Such tea is usually infused in hot water, the spent tea leaves are then removed and a hot beverage, to which other ingredients may be added, is consumed in most countries.

When hot aqueous infusions of black leaf tea are prepared, it is found that the infusion comprises substances that are soluble in hot water but insoluble in cold water, which substances therefore tend to precipitate as the infusion cools. These cold water insoluble substances comprise polyphenol-protein-caffeine complexes (known as tea “cream”), and typically comprise 20-40% of the total tea solids present in the infusion. Further, numerous compounds in the leaves, that give the beverage its unique organoleptic properties, are only sparingly soluble in cold water.

However, it is desirable to have concentrated cold water soluble tea products from which one can make tea based beverages with good organoleptic properties as these are very popular due to the convenience of use. They can also be used to prepare iced tea drinks that are very popular in some countries. The concentrated cold water soluble tea products may be liquid or they may be dried to give powders.

Several processes have been proposed to obtain cold water soluble or ‘instant’ tea. The most common process, as disclosed in United States patent specification U.S. Pat. No. 3,163,539 (Standard Brands Inc), involves extraction from black tea leaves, alkali treatment to solubilise the tea solids, and centrifugation to remove any remaining cold-insoluble tea solids. Such powders when dissolved in water have good colour and clarity.

However, the alkali process makes use of chemicals and involves the use of refrigeration equipment that is expensive. There has therefore been an effort in the industry to replace the alkali process. The few processes known in the prior art that avoid the use of alkali make use of natural ingredients/enzymes in the process. However, these processes give tea powders that provide hazy tea liquors or infusions with very light colours.

United States patent specification U.S. Pat. No. 4,639,375 (Procter & Gamble) discloses treating black tea with tannase, together with other cell-wall digesting enzymes, to generate cold-water soluble instant tea powders.

Japanese patent specification JP 51128499 A2 (Meijiya Shokuhin Kojo KK) relates to a method to prevent turbidity in an infusion of black tea by adding caramel and citric acid. The black tea infusion, citric acid, sugar and caramel are added together and tea is prepared. The clarity of the solution was maintained even on storage for eight months at room temperature. Caramel obtained from sugar, starch and glucose may be used for the invention.

United States patent specification U.S. Pat. No. 4,717,579 (The Procter & Gamble Co.) relates to frozen tea mix concentrates which contain high levels of sugar and are flowable at freezer temperatures. These tea mix concentrates comprise from about 0.5 to about 2% by weight tea solids and from about 40 to about 70% by weight of a sugar component that is a particular mixture of fructose and dextrose monosaccharides, sucrose, glucose-based di- and tri-saccharides selected from maltose, isomaltose, maltotriose, isomaltotriose. The tea mix concentrates can include an edible acid to provide a lower pH (about 4 or less at 20° C.), a flavouring such as lemon and caramel.

European patent specification EP 1040762 A (Unilever) discloses a process for preparing tea concentrate without using alkali. By treating an extract of tea leaves containing at least 5% soluble tea solids with air or oxygen and a cell wall material from a vegetable source, example rice husk.

The present invention addresses the problem of making a concentrated cold water soluble tea product by a process that avoids the use of alkali and gives a product that dissolves in cold water to give a tea beverage that has good colour and clarity. The present applicants have solved that problem by mixing an extract of tea material with an anionic colloidal material while making a concentrated cold water soluble tea product.

### STATEMENT OF THE INVENTION

The invention can be said in broad terms to relate to a process for making a concentrated cold water soluble tea product comprising the steps of extracting tea material with water to give a tea extract, deleafing the tea extract, concentrating the deleafed tea extract, decreaming the concentrated tea extract, and concentrating the decreamed tea extract to give a concentrated cold water soluble tea product, the process being characterised in that an anionic colloidal material is added between the deleafing step and the decreaming step.

The anionic colloidal material is preferably caramel, especially a class IV caramel.

The concentrated cold water soluble tea products may be a liquid which can be diluted to give a tea beverage with good clarity and colour. Alternatively the concentrated cold water soluble tea products can be dried to give a cold water soluble instant tea or a cold water soluble ready to drink tea powder from which one can make a tea beverage with good clarity and colour.

“Tea” for the purpose of this invention means leaf material obtained from the tea plants such as Camellia sinensis var. sinensis or Camellia sinensis var. assamica. It also includes rooibos tea obtained from Aspalathus linearis, however, this is a poor source of endogenous fermenting enzymes. The term ‘tea’ also encompasses the product of blending two or more of these teas.

“Tea material” is intended to mean vegetatable material obtained from the tea plant. It could be freshly plucked tea leaves, dried tea be that black, oolong or green tea, low grade leaf tea, or mixtures thereof.

“Concentrated cold water soluble tea product” is intended to mean a product that is formed by extracting tea material with a solvent to give a tea extract which has been concentrated by removal of some or all of the solvent.

“Cold water soluble” is intended to mean substantially in cold water i.e. water having a temperature of about 4° C.

“Tea beverage” is intended to mean a beverage containing tea which is in a form suitable for ingestion by the consumer

All parts herein are by weight unless otherwise specified.

Except in the operating and comparative examples, or where otherwise explicitly indicated, all numbers in this description indicating amounts or concentrations of material ought to be understood as modified by the word “about”.

For the avoidance of doubt the word “comprising” is intended to mean including but not necessarily “consisting of” or “composed of”. In other words the listed steps or options need not be exhaustive.

### DETAILED DESCRIPTION OF THE INVENTION

The process of the present invention will now be described in detail with reference to a preferred embodiment.

### Extraction

Tea material is extracted in hot water. The tea material is preferably freshly manufactured leaf tea. However one can obtain a good quality concentrated cold water soluble tea product using even a low grade made tea such as broken mixed fannings of black tea. The tea material is preferably extracted in water having a temperature of 60 to 100° C., more especially around 90° C. for at least 5 minutes. This can be suitably carried out in a steam jacketed vessel with agitation.

### Deleafing

After extraction, the tea extract is de-leafed i.e. extraneous leaf material such as stalk is removed. This can be carried out using a screw press and then passing the hot liquor through a centrifuge to remove fines.

### Concentration

The deleafed tea extract tends to contain 2 to 4% soluble tea solids. As a practical matter it is best to concentrate the deleafed extract to a solids content of 8 to 12% (concentrated tea extract). This significantly lowers the volume of liquid that needs to be processed. Any suitable known means or process can be used for that purpose for example a falling film scraped surface heat exchanger.

### Addition of Anionic Colloidal Material

A colloidal anionic material is mixed with the concentrated tea extract to improve the clarity of the extract (i.e. minimise haze) and add colour (i.e. make it richer and darker). While not wanting to be bound by theory, the present inventors believe that the molecules of the negatively charged colloidal material are located between the “tea molecules” in the extract and keeps the tea molecules apart in solution so that they do not aggregate and form tea cream. The colloidal material molecules repel each other as well as the tea molecules since they have the same type of charge (negative) as that of the tea molecules in a natural infusion of tea.

Preferably, the anionic colloidal material is added at 5-40% by weight of the soluble tea solids, more preferably, the anionic colloidal material is added at 5 to 30% by weight of soluble tea solids and most preferably at 10 to 20% by weight of soluble tea solids.

The anionic colloidal material is preferably caramel.

Caramel is the dark brown material that results from the carefully controlled heat treatment of food grade carbohydrates. When used in low concentrations caramel adds colour but not flavour so it is known in the industry as a colouring agent. Caramel colour is defined and regulated as a food colour additive. Internationally the joint FAO/WHO Expert Committee on Food Additives (JECFA) has divided caramel colour into four classes depending on the food grade reactants used in the manufacturing. Class I is plain caramel colour, Class II is caustic sulphite process caramel colour, Class III is ammonia process caramel colour, and Class IV is sulphite ammonia process caramel colour.

Caramel colour molecules carry ionic (electrochemical) charges that may be either positive or negative depending upon the processing conditions of a particular product. For the purposes of the present invention the caramel should have the same type of charge as tea molecules i.e. negative, as it is the mutual repulsion of the caramel and the tea molecules that significantly minimises the formation of haze. Class IV caramel tends to be strongly negatively charged at pH>2.0 and thus it is the preferred colloidal anionic material for the purposes of the present invention.

In the preferred embodiment, the concentrated tea extract containing 8-12% solids is placed in a steam jacketed vessel. Class IV caramel is added to this liquor and the mixture is preferably heated to 50 to 100° C., especially 60 to 90° C., and held at that temperature for at least 5 minutes. This heating step helps to mix the anionic colloidal material and the concentrated tea extract. The mixture of the anionic colloidal material and the concentrated tea extract is then cooled or allowed to cool to a temperature of less than 50° C., for example less than 30° C., preferably between 10 and 50° C., especially between 20 and 30° C. This encourages the cold water insoluble tea solids to fall out of solution as a tea cream.

In the preferred embodiment described above the anionic colloidal material is added to the concentrated deleafed tea extract although it could be added at any stage between the deleafing step and the decreaming step.

### Decreaming

The mixture of concentrated extract and anionic colloidal material is decreamed or “polished” to remove the insoluble tea cream. This can be achieved by centrifuging the extract at 10 to 50° C. more preferably at 20 to 30° C., and discarding the tea cream.

### Concentration

The decreamed extract is further concentrated to 25 to 50% solids to yield a concentrated cold water soluble tea product. This concentrated cold water soluble tea product can be used as it is for dilution to provide a tea beverage. Alternatively the concentrated cold water soluble tea product may be dried, for example in a spray drier, to yield a cold water soluble tea powder. That powder can be used as an instant tea product or a Ready to drink tea powder. Beverages made from such a product or powder are substantially clear (e.g. haze<20 NTU) with good colour (e.g. L<85) at low pH (e.g. at least 2.5).

The invention will now be described with reference to the following examples. The examples are intended to illustrate particular embodiments of the invention, and not imply any limitation on the scope of this invention.

### EXAMPLES

### Example 1

### A Concentrated Cold Water Soluble Tea Product in Powder Form Made by Process According to the Present Invention

The raw material used in the process was tea material sourced from Assam. The tea material was extracted with water in a steam jacketed vessel for ten minutes at 900 C. After extraction, the tea extract was deleafed in a screw press and the hot liquor was passed through a centrifuge to remove the fines. The deleafed tea extract thus obtained had a solids content of around 3%. It was then concentrated in a falling film scraped surface heat exchanger to a solids content of 10%.

The concentrated tea extract was placed in a steam jacketed vessel where negatively charged and colloidal caramel (Class IV caramel) was added at 20% by weight of the tea solids. The mixture was then heated to around 90° C. and was held at that temperature for 10 minutes. The mixture was then cooled to a temperature of 27° C. and was passed through a centrifuge. It was then further concentrated to around 30% solids and spray dried to obtain a tea powder. The powder was dark brown in colour.

### Comparative Example A

### A Concentrated Cold Water Soluble Tea Product in Powder Form Made by the Conventional Chemical Process

The raw material used in the process was tea material sourced from Assam. The tea material was subjected to extraction with water in a steam jacketed vessel for ten minutes at 90° C. After extraction, the slurry was deleafed in a screw press and the hot liquor was passed through a centrifuge to remove the fines. The liquor thus obtained had a solids content of around 3%. It was then concentrated in a falling film scraped surface heat exchanger to a solids content of 10%. Then, the concentrate was chilled to 3° C. and decreamed i.e., it was passed through a centrifuge to obtain two streams: a supernatant called decreamed liquor and a sediment layer called cream.

A portion of the decreamed liquor was mixed with the cream obtained and it was subjected to treatment with alkali at a temperature of 90° C. for 30 minutes to solubilise tea solids. Alkali was typically added at 30% by weight of the tea solids taken for solubilisation. After the solubilisation with alkali, air sparging was done for around one hour.

The solubilised liquor was then added back to the rest of the decreamed liquor (untreated) and the pH of the blend was adjusted to the natural pH of tea extracts (just above 5). The blend was then chilled and passed through a centrifuge. The supernatant liquor was concentrated and spray dried to obtain tea powder. The powder was dark brown-black in colour and milled to a desired particle size.

### Comparative Example B

### Tea Powder Made Using Non-anionic Non-colloidal Caramel

The raw material used in the process was tea material sourced from Assam. The tea material was subjected to extraction with water in a steam jacketed vessel for ten minutes at 90° C. After extraction, the slurry was deleafed in a screw press and the hot is liquor was passed through a centrifuge to remove the fines. The liquor thus obtained had a solids content of around 3%. It was then concentrated in a falling film scraped surface heat exchanger to a solids content of 10%.

The concentrated liquor was taken in a steam jacketed vessel where caramel (non-colloidal, non-anionic) was added at 20% by weight of the tea solids. The concentrate was then heated to around 90° C. and was held at that temperature for 10 minutes. The liquor was then cooled to a temperature of 27° C. and was passed through a centrifuge. It was then further concentrated to around 30% solids and spray dried to obtain the tea powder. The powder was light brown in colour.

### Example 2

### Comparison of Tea Liquor Properties

The data on the properties of the aqueous infusion (drink) obtained from tea powders prepared by the process of the invention (Example 1) as well as processes outside the invention (Comparative Examples A and B) are presented in Table 1 below.

The colour of the drinks (as expressed in terms of L) was measured using a MINOLTA™ chromometer in the transmittance mode. Haze was measured using a DR. LANGE™ nephelometer and the results are expressed in normalised turbidity units (NTU's). The higher the value, the hazier of the tea liquor. Caffeine determination was achieved using a spectrophotometric method after extraction into a suitable solvent. An ambient storage study was carried out on the drinks and the colour and haze were monitored over a period of three months.

TABLE 1
Comparison of tea powders

| Example | Colour (L) | Haze (NTU) | Caffeine (%) | Stability |
|---|---|---|---|---|
| 1 | 81 | 8.2 | 4.6 | Good |
| A | 77 | 5 | 2.5 | Good |
| B | 87.5 | 25 | 4.6 | Poor |

The data shows that the tea liquor prepared by the process of the invention provides for teas that have L and haze parameters similar to the alkali process and a higher caffeine content. The process of the invention is also superior to other non-alkali processes (Comparative Example B). Hence the process of the invention can indeed provide teas that contain more soluble tea solids and give good colour and clarity. The storage stability of the powders is also good. It has thus been possible by this invention to get concentrated cold water soluble tea products with desirable at tributes without using alkali in the process.

1. A process for making a concentrated cold water soluble tea product comprising the steps of extracting tea material with water to give a tea extract, deleafing the tea extract, concentrating the deleafed tea extract, decreaming the concentrated tea extract, and concentrating the decreamed tea extract to give a concentrated cold water soluble tea product, the process being characterised in that an anionic colloidal material is added between the deleafing step and the decreaming step.

2. A process according to claim 1, wherein the tea material is extracted in water at a temperature of 60 to 100° C.

3. A process according to claim 1, wherein the deleafed tea extract is concentrated to 8 to 12% tea solids.

4. A process according to claim 1, wherein the anionic colloidal material is added to the concentrated deleafed tea extract.

5. A process according to claim 1, the anionic colloidal material is added at 5 to 40% by weight of the soluble tea solids.

6. A process according to claim 1, wherein the anionic colloidal material is a class IV caramel.

7. A process according to claim 1, wherein the decreamed tea extract is heated to at 50 to 100° C. and then cooled to 10 to 50° C. before concentrating the decreamed tea extract.

8. A process according to claim 1, wherein the decreamed tea extract is concentrated to 25-50% tea solids.

9. A process for preparing a cold water soluble tea powder comprising preparing a cold water soluble tea concentrate according to the process of any one of claims 1 to 8 and drying the concentrate to form a cold water soluble tea powder.

10. A process for preparing a tea beverage comprising preparing a concentrated cold water soluble tea product according to the process of any one of claims 1 to 8 and mixing that with water to give a tea beverage.

11. A process for preparing a tea beverage comprising preparing a cold water soluble tea powder according to the process of claim 9 and dissolving that powder into water to give a tea beverage.
